(19) United States
(12) Patent Application Publication
(10) Pub. No.: US 2016/0010801 A1
(43) Pub. Date: Jan. 14, 2016

(54) Scuba Tank to Air Chuck Adapter

(71) Applicants: Charles Edmond McWilliam, SR., Boulder City, NV (US); Jamie George McWilliam, Boulder City, NV (US)

(72) Inventors: Charles Edmond McWilliam, SR., Boulder City, NV (US); Jamie George McWilliam, Boulder City, NV (US)

(21) Appl. No.: 14/330,239

(22) Filed: Jul. 14, 2014

(51) Int. Cl. F17C 13/00; B63B 7/08

(52) U.S. Cl. CPC F17C 13/002; B63B 7/08

(57) ABSTRACT

A device is described for obtaining compressed gas from a scuba tank for low pressure applications. One end of the device consists of a male standard BCD (Buoyancy Control Device) inflator stem (2), which may connect to the low pressure hose of a first-stage regulator (6). The other end of the device consists of a female air chuck quick couple fitting (1), which may connect to any commercial air chuck (4). This will allow gas from a scuba tank to be used in most low-pressure applications, including, but not limited to, filling tires, water pressure tanks, and/or air bladders, spray painting, pressure cleaning, and/or air pressure drying.

### BACKGROUND OF THE INVENTION

This invention relates in general to a method for adapting high pressure gas for low pressure applications.

In maritime-related fields, it is often necessary to have a supply of low-pressure gas for spray painting, air drying, and/or to fill inflatable boats and/or other air bladders, water pressure tanks, tires, and/or other low pressure applications.

### SUMMARY OF THE INVENTION

This invention relates to a device and method for adapting high pressure air for low pressure applications. The device may connect to the low pressure hose of a scuba diving regulator, adapting the hose to any commercial air chuck. The device may allow the user to easily spray paint, fill inflatable boats and/or other air bladders—with the addition of a needle may inflate sports balls—water pressure tanks, tires, and/or other low pressure applications from gas stored in a scuba tank.

### BRIEF DESCRIPTION OF THE DRAWING

FIG. 1 is a diagrammatic representation of the invention.

FIG. 2 is a diagrammatic representation of the invention (adapter for air chuck) as used in the system for obtaining low pressure air.

### DRAWINGS

### Reference Numerals

1 female quick couple air chuck

2 male standard BCD inflator stem

3 invention (adapter for air chuck)

4 any air chuck with quick couple fitting

5 female standard BCD inflator fitting (attached to low pressure hose)

### DETAILED DESCRIPTION OF THE INVENTION

This device may allow the user to use the high pressure gas from a scuba tank to perform various functions requiring low pressure compressed gas.

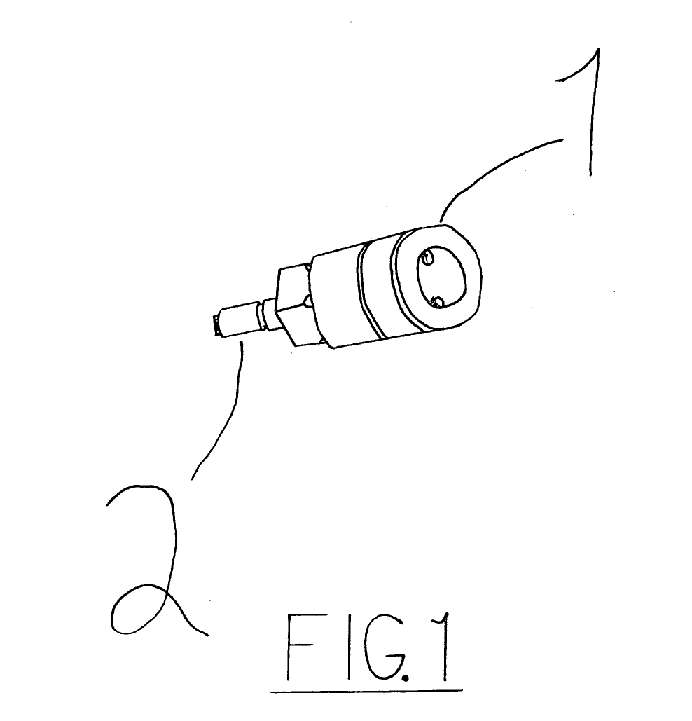

The device is illustrated in FIG. 1. It consists of an adapter, one end a male standard BCD inflator stem (2), and the other a female air chuck quick couple connection (1).

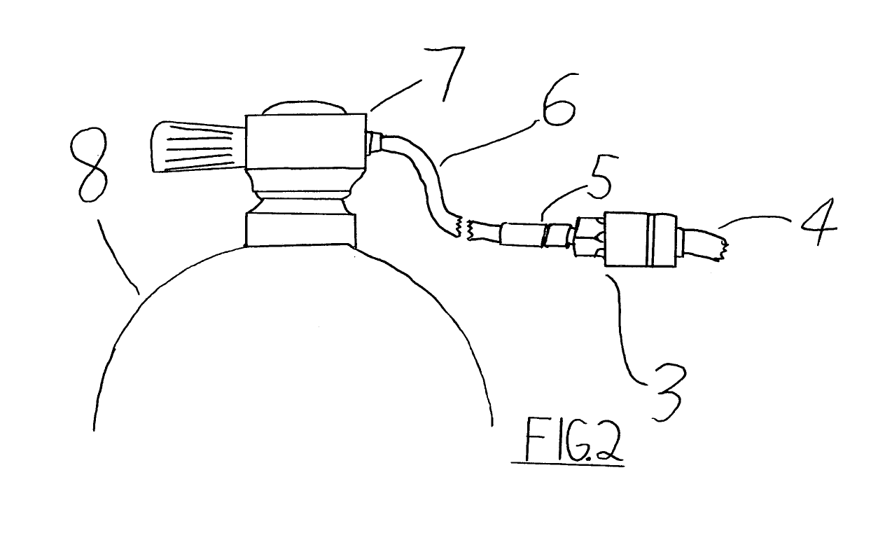

The use of the adapter (FIG. 1) is illustrated in FIG. 2. The male standard BCD inflator stem (2) of this device may connect to the low pressure hose (6) of the first stage regulator (7) attached to the scuba tank (8). Any commercial air chuck with quick couple connection (4) may then be attached to the female air chuck quick couple connection (1), providing low pressure compressed air to most attachments, including, but not limited to, spray guns, tire chucks, and/or air nozzles.

What is claimed is:

1. A device for obtaining low pressure air from a scuba tank via the low pressure hose of a first stage regulator, comprising:
(a) a female air chuck quick couple fitting,
(b) a male standard BCD (Buoyancy Control Device) inflator stem,
(c) the previous components connected in a manner that allows air to flow between them.

2. A method for obtaining low pressure air from a scuba tank, comprising:
(a) the device from claim 1,
(b) said device being connected to a low pressure hose of a first stage regulator,
(c) said first stage regulator being attached to a scuba tank, whereby allowing low pressure gas from the tank to flow to any air chuck attached to the device from claim 1.
